(19) United States
(12) Patent Application Publication
(10) Pub. No.: US 2019/0391756 A1
(43) Pub. Date: Dec. 26, 2019

(54) DATA STORAGE DEVICE AND CACHE-DIVERSION METHOD THEREOF

(71) Applicant: Shannon Systems Ltd., Shanghai (CN)

(72) Inventors: Defu WANG, Shanghai (CN); Xunsi LIU, Shanghai (CN)

(21) Appl. No.: 16/112,900

(22) Filed: Aug. 27, 2018

(30) Foreign Application Priority Data
Jun. 26, 2018 (CN) 201810669304.5

(51) Int. Cl. G06F 3/06; G06F 12/06

(52) U.S. Cl. CPC G06F 3/0659; G06F 3/0611; G06F 3/068; G06F 2212/604; G06F 12/0646; G06F 2212/1024; G06F 2212/205; G06F 3/0631

(57) ABSTRACT

A data storage device is provided. The data storage device includes: a flash memory, a dynamic random-access memory (DRAM), and a controller. The flash memory includes a plurality of physical blocks for storing data. The controller is configured to allocate a cache space from the DRAM according to at least one data feature of a write command from a host. The controller writes first data indicated by the write command into the cache space. In response to receiving a read command from the host, the controller determines whether the cache space contains all of the second data indicated by the read command. When the cache space contains all of the second data indicated by the read command, the controller retrieves the second data indicated by the read command directly from the cache space.

### CROSS REFERENCE TO RELATED APPLICATIONS

This Application claims priority of China Patent Application No. 201810669304.5, filed on Jun. 26, 2018, the entirety of which is incorporated by reference herein.

### BACKGROUND OF THE INVENTION

### Field of the Invention

The present invention relates to data storage devices and in particular to a data storage device and a cache-diversion method thereof.

### Description of the Related Art

A flash memory is a common non-volatile data-storage medium, and can be electrically erased and programmed. For example, a NAND flash memory is usually used as a storage medium such as a memory card, a USB flash device, a solid-state disk (SSD), or an embedded multimedia card (eMMC) module.

The storage array in a flash memory (e.g., a NAND flash memory) includes a plurality of blocks, and each block includes a plurality of pages. How to efficiently use blocks in the flash memory is an important issue since the number of blocks in the flash memory is limited.

### BRIEF SUMMARY OF THE INVENTION

In an exemplary embodiment, a data storage device is provided. The data storage device includes: a flash memory, a dynamic random-access memory (DRAM), and a controller. The flash memory includes a plurality of physical blocks for storing data. The controller is configured to allocate a cache space from the DRAM according to at least one data feature of a write command from a host. The controller writes first data indicated by the write command into the cache space. In response to receiving a read command from the host, the controller determines whether the cache space contains all of the second data indicated by the read command. When the cache space contains all of the second data indicated by the read command, the controller retrieves the second data indicated by the read command directly from the cache space.

A cache-diversion method for use in a data storage device is provided. The data storage device includes a flash memory and a dynamic random-access memory (DRAM). The method includes the steps of: allocating a cache space from the DRAM according to at least one data feature of a write command from a host, writing first data indicated by the write command into the cache space; in response to receiving a read command from the host, determining whether the cache space contains all of the second data indicated by the read command; and when the cache space contains all of the second data indicated by the read command, retrieving the second data indicated by the read command directly from the cache space.

### BRIEF DESCRIPTION OF THE DRAWINGS

The present invention can be more fully understood by reading the subsequent detailed description and examples with references made to the accompanying drawings, wherein:

FIG. 1 is a block diagram of an electronic system in accordance with an embodiment of the invention;

FIG. 2A is a diagram of a cache controller writing data into cache spaces in accordance with an embodiment of the invention;

FIG. 2B is a diagram of the cache controller reading data from the cache spaces according to the embodiment of FIG. 2A;

FIG. 2C is a diagram of writing mixed data of various stream commands into the flash memory in accordance with an embodiment of the invention;

FIG. 2D is a diagram of writing data of various stream commands into the flash memory according to the stream IDs in various stream commands in accordance with to an embodiment of the invention;

FIG. 2E is a diagram of writing data of various stream commands into the flash memory according to the stream IDs in various stream commands in accordance with to an embodiment of the invention; and

FIG. 3 is a flow chart of a cache-diversion method for use in a data storage device in accordance with an embodiment of the invention.

### DETAILED DESCRIPTION OF THE INVENTION

The following description shows exemplary embodiments carrying out the invention. This description is made for the purpose of illustrating the general principles of the invention and should not be taken in a limiting sense. The scope of the invention is best determined by reference to the appended claims.

A non-volatile memory may be a memory device for long-term data retention such as a flash memory, a magnetoresistive RAM, a ferroelectric RAM, a resistive RAM, a spin-transfer-torque RAM (STT-RAM) and so on. The following discussion is regarding flash memory in particular as an example, but it is not intended to be limited thereto.

The flash memory is often used as a storage medium in today's data storage devices that can be implemented by a memory card, a USB flash device, an SSD and so on. In another exemplary embodiment, the flash memory 100 is packaged with a controller to form a multiple-chip package or an embedded flash-memory module such as an embedded Multi Media Card (eMMC) module.

The data storage device that includes the storage medium of the flash memory can be used on various electronic devices such as a smartphone, a wearable device, a tablet PC, or a virtual-reality (VR) device. The computation module of the electronic device can be regarded as a host for controlling the data-storage device of the electronic device to access the flash memory of the data-storage device.

The data storage device implemented by the flash memory can be used to build a data center. For example, the server may operate an SSD array to form the data center. The server can be regarded as a host for controlling the SSDs connected to the server, thereby accessing the flash memories of the SSDs.

The host may recognize user data using logical addresses such as logical block addresses (LBAs), global host-page (GHP) numbers, host blocks (HBLKs), host pages (HPages). After the user data is written into the flash memory, the mapping relationships between the logical address and the physical address in the flash memory are recorded by the control unit of the flash memory. When the host is to read the user data from the flash memory at a later time, the control unit may provide the user data stored in the flash memory according to the mapping relationships.

The flash memory can be used as the storage medium of a data storage device, and the flash memory includes a plurality of blocks, and each block includes a plurality of pages. The minimum unit for an erasing operation in the flash memory is a block. After a block (e.g., a data block) is erased, the block may become a spare block which may become a data block again after user data is written into the spare block. When the user data is written into a block page by page, the logical address of each page in the block for storing the user data should be dynamically integrated into a physical-to-logical mapping table (e.g., a P2L table or a flash-to-host (F2H) table). In an embodiment, the spare blocks arranged for receiving the user data are regarded as active blocks, and the spare blocks that are used for receiving the user data from the source blocks in a garbage-collection procedure are regarded as destination blocks. The physical-to-logical mapping table between the active blocks and destination blocks can be dynamically integrated in a volatile memory. For example, the static random-access memory (SRAM) used by the control unit or controller of the data storage device can be used to dynamically integrate the physical-to-logical mapping table (i.e., F2H table). Then, the mapping relationships between the physical addresses and logical addresses can be inversely converted to update the logical-to-physical mapping table (i.e., H2F table). The control unit may store the whole or the updated portion of the logical-to-physical mapping table to the flash memory. Generally, the physical-to-logical mapping table that is dynamically updated according to the active blocks or destination blocks of the flash memory can be regarded as a “small mapping table”, and the logical-to-physical mapping table that is stored in a non-volatile manner in the flash memory can be regarded as a “big mapping table”. The control unit may integrate the mapping information recorded by all or a portion of the small mapping table into the big mapping table, and then the control unit may access the user data according to the big mapping table.

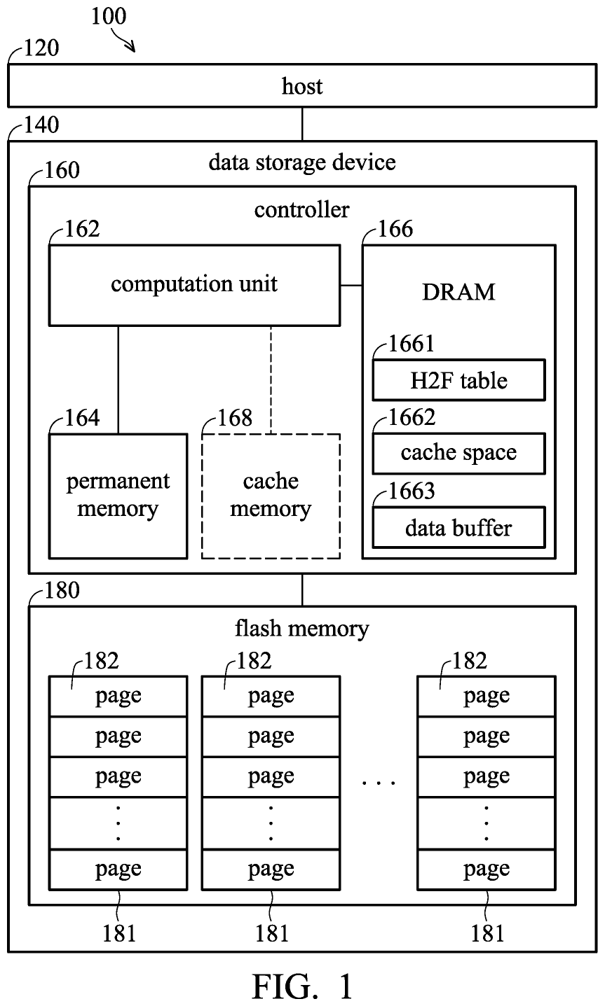

FIG. 1 is a block diagram of an electronic system in accordance with an embodiment of the invention. The electronic system 100 may be a personal computer, a data server, a network-attached storage (NAS), a portable electronic device, etc., but the invention is not limited thereto. The portable electronic device may be a laptop, a hand-held cellular phone, a smartphone, a tablet PC, a personal digital assistant (PDA), a digital camera, a digital video camera, a portable multimedia player, a personal navigation device, a handheld game console, or an e-book, but the invention is not limited thereto.

The electronic system 100 includes a host 120 and a data storage device 140. The data storage device 140 includes a flash memory 180 and a controller 160, and the controller 120 may control the flash memory 180 according to the command from the host 120. The controller 160 includes a computation unit 162, a permanent memory (e.g., a read-only memory) 164, and a dynamic random-access memory (DRAM) 166. The computation unit 162 may be a general-purpose processor or a microcontroller, but the invention is not limited thereto.

The permanent memory 164 and the loaded program codes and data form firmware that is executed by the computation unit 162, so that the controller 160 may control the flash memory 180 according to the firmware. The dynamic random-access memory 166 is configured to load the program codes and parameters that are provided to the controller 160, so that the controller 160 may operate according to the program codes and parameters loaded into the dynamic random-access memory 166. In an embodiment, the dynamic random-access memory 166 can be used as a data buffer 1663 configured to store the write data from the host 120. In response to the data stored in the dynamic random-access memory 166 have reaching a predetermined size, the controller 160 may write the data stored in the dynamic random-access memory 166 into the flash memory 180. In addition, the computation unit 162 may load all or a portion of the logical-to-physical mapping table 1661 from the flash memory 180 to the dynamic random-access memory 166.

In some embodiments, the data storage device 140 further includes a cache memory 168 that is a volatile memory such as a static random-access memory (SRAM) or other types of static memories capable of quickly accessing data with a faster speed than the dynamic random-access memory. The cache memory 168 is configured to store frequently accessed data or hot data stored in the flash memory 180. In some embodiments, the cache memory 168 and the controller 160 can be packaged with the controller in the same chip package. In addition, the dynamic random-access memory 166 can be packaged into the same chip package or independently disposed outside the chip packet of the controller 160.

In some embodiments, the dynamic random-access memory 166 may replace the cache memory 168. That is, the dynamic random-access memory 166 may be used as a cache memory. In some embodiments, the dynamic random-access memory 166 may be allocated one or more cache spaces for storing different types of data, and the details will be described later. For purposes of description, the dynamic random-access memory 166 allocated with one or more cache spaces 1662 is used in the following embodiments.

The flash memory 180 includes a plurality of blocks 181, wherein each of the blocks 181 includes a plurality of pages 182 for storing data.

In an embodiment, the host 120 and the data storage device 140 may connect to each other through an interface such as a Peripheral Component Interconnect Express (PCIe) bus, or a Serial Advanced Technology Attachment (SATA) bus. In addition, the data storage device 140, for example, may support the Non-Volatile Memory Express (NVMe) standard.

The host 120 may write data to the data storage device 140 or read the data stored in the data storage device 140. Specifically, the host 120 may generate a write command to request writing data to the data storage device 140, or generate a read command to request reading data stored in the data storage device 140. The write command or the read command can be regarded as an input/output (I/O) command.

When the host 120 sends a read command to read data from the data storage device 140, the computation unit 162 may determine whether the to-be-accessed data exists in the cache space of the dynamic random-access memory 166. If the to-be-accessed data exists in the cache space of the dynamic random-access memory 166, the computation unit 162 may retrieve the to-be-accessed data directly from the corresponding cache space of the dynamic random-access memory 166, and transmit the retrieved data to the host 120 to complete the read operation.

When the host 120 sends a write command to write data to the data storage device 140, the computation unit 162 may determine the attribute of the write command, and write the data into a corresponding cache space of the dynamic random-access memory 166 according to the attribute of the write command.

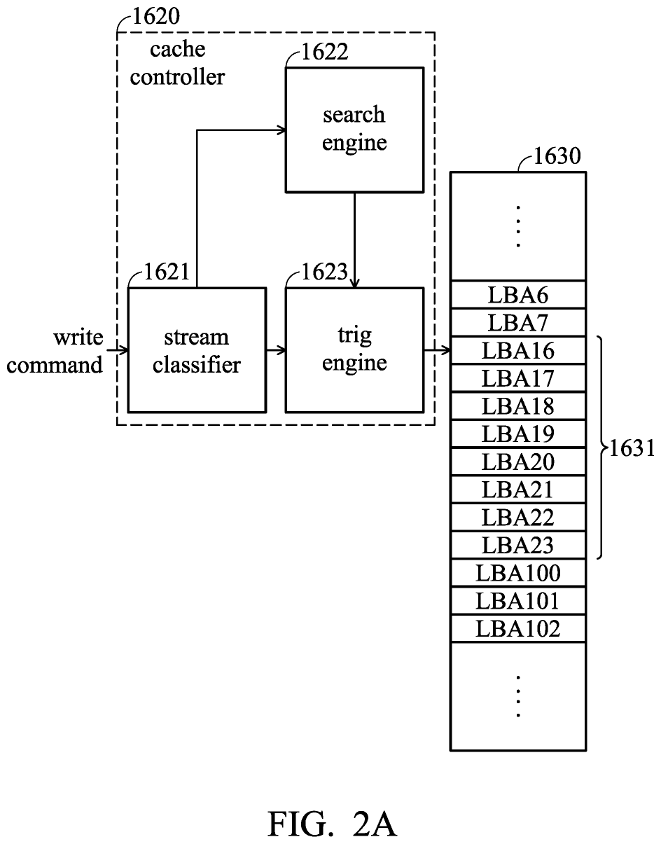

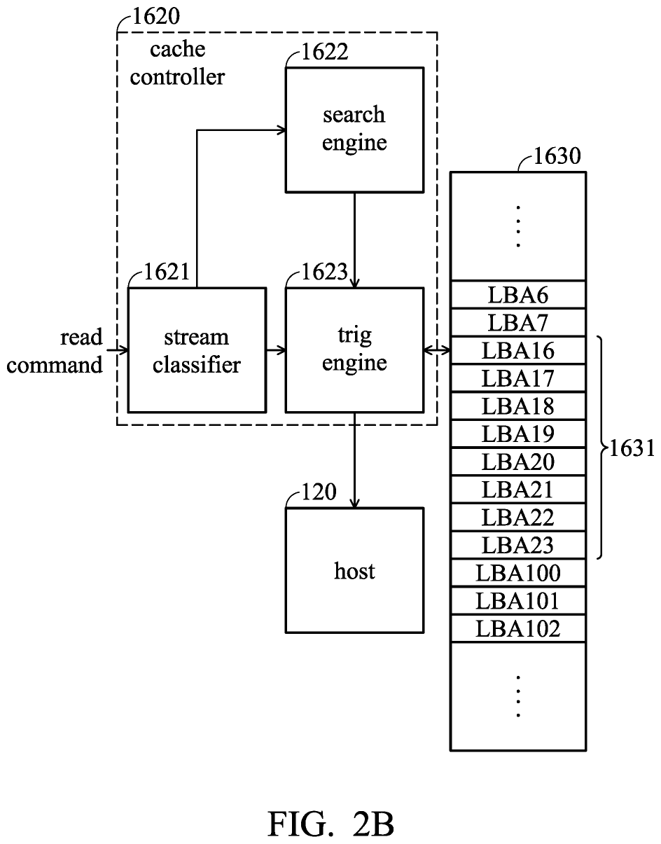

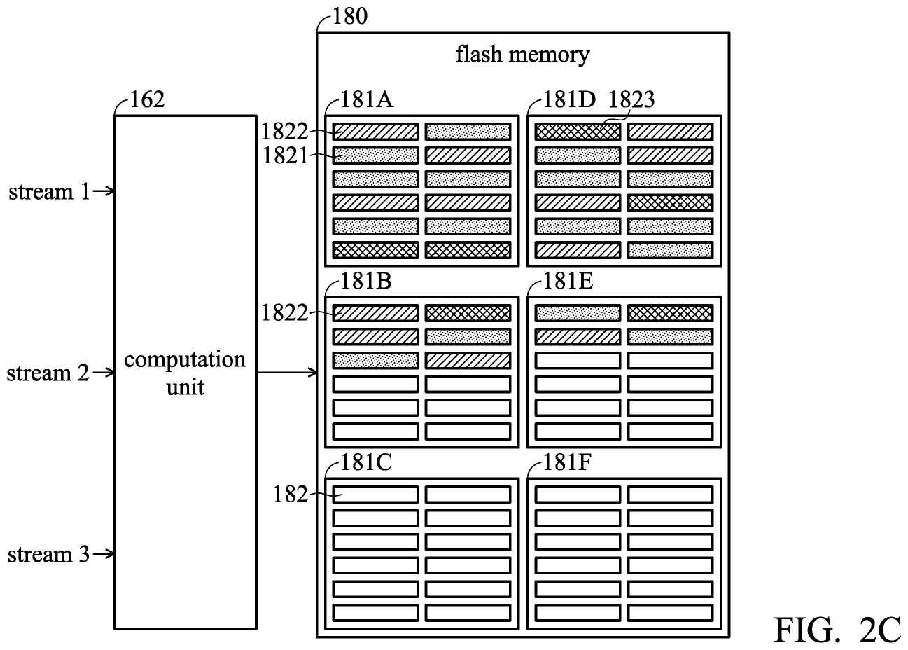

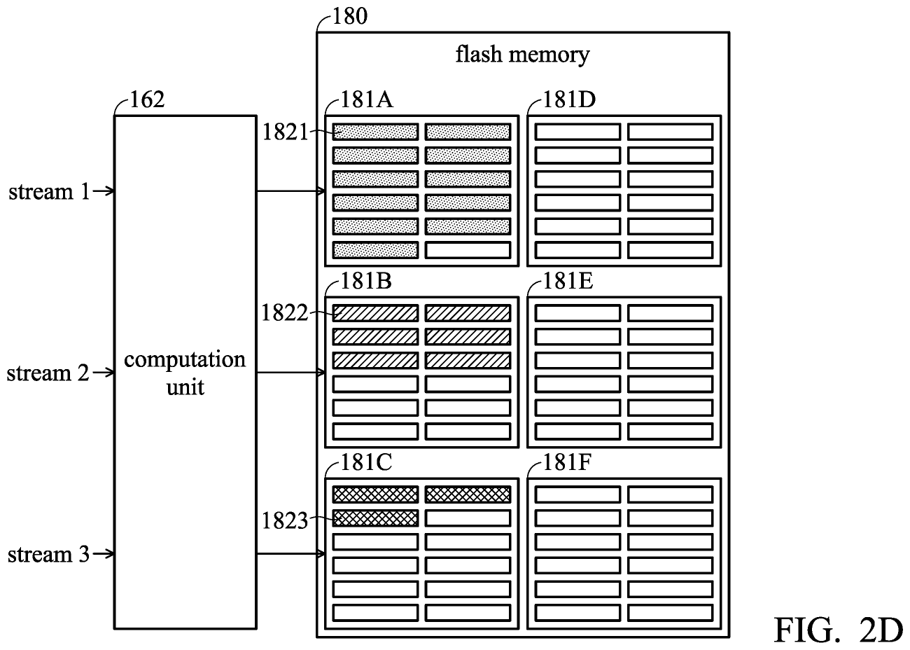

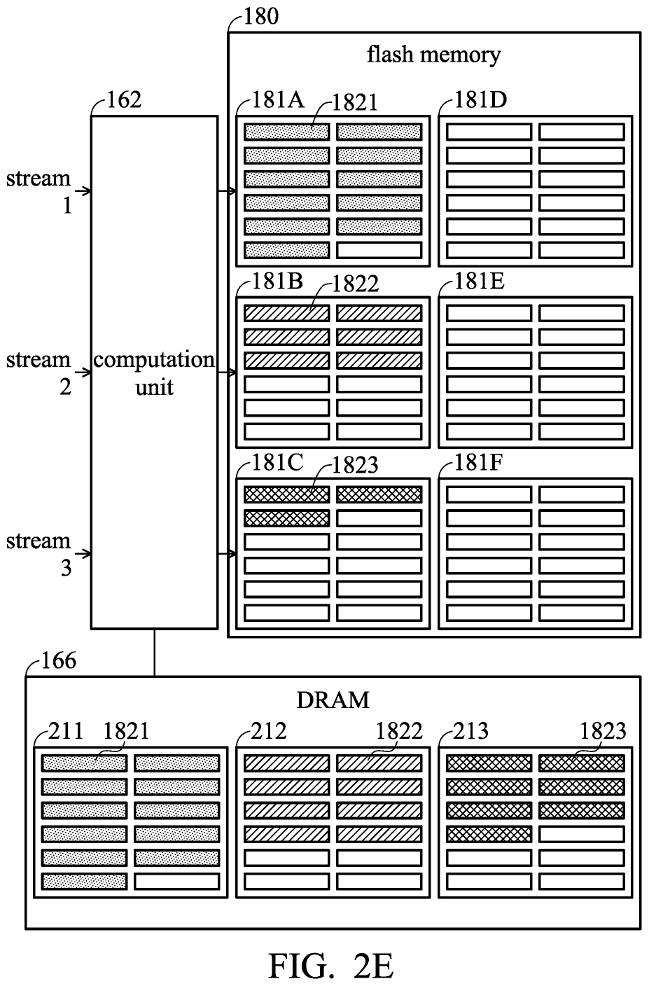

FIG. 2A is a diagram of a cache controller writing data into cache spaces in accordance with an embodiment of the invention. FIG. 2B is a diagram of the cache controller reading data from the cache spaces according to the embodiment of FIG. 2A.

As illustrated in FIG. 2A, the computation unit 162 may include a cache controller 1620, and the cache controller 1620 includes a stream classifier 1621, a search engine 1622, a trig engine 1623. In some embodiments, the cache controller 1620 may be an independent control circuit that is electrically connected to the computation unit 162 and the dynamic random-access memory 166.

The stream classifier 1621 is configured to classify the I/O command from the host 120. For example, the stream classifier 1621 may classify the I/O command from the host 120 using a stream ID, a namespace ID, or data attributes, but the invention is not limited thereto.

The search engine 1622 is configured to search the data stored in each of the cache spaces, and transmit a start address and a length to the trig engine 1623.

The trig engine 1623 may, according to the start address (e.g., a logical address) and the length indicated by the I/O command from the search engine 1622, receive the write command from the stream classifier 1621 to write data into a corresponding cache space (e.g., the cache space 1630 shown in FIG. 2A), or receive the read command from the stream classifier 1621 to read data from the corresponding cache space.

Specifically, the search engine 1622 may build a cache lookup table (not shown) in the dynamic random-access memory 166, and the cache lookup table records the mapping relationships between the logical addresses and cache addresses in different cache spaces. For example, in an embodiment, when the data storage device 140 is in the initial condition, each cache space does not store data. When the host 120 sends a write command (e.g., a stream write command or other types of write commands) to the data storage device 140, the stream classifier 1621 may classify the write command from the host 120 using a stream ID, a namespace ID, or data attributes (e.g., distribution of logical addresses, or data sizes). For example, each namespace ID may correspond to a respective cache space. That is, each cache space may have an individual range of logical addresses in the dynamic random-access memory 166.

In some embodiments, the stream classifier may classify the write command from the host 120 according to the logical address the size of the data indicated by the write command. For example, the size of data indicated by the write command may be 4K, 16K, or 128K byes (not limited), and thus the write commands indicating different size of data can be classified into different types. The stream classifier 1621 may also calculate the distribution of the logical addresses indicated by each of the write commands from the host 120, and divide the logical addresses into a plurality of groups, where each of the groups corresponds to a stream. In addition, the stream classifier 1621 may classify the write commands from the host 120 in consideration of both the logical addresses and the size of data indicated by the write commands.

Briefly, the stream classifier 1621 may classify the write commands from the host 120 according to at least one data feature of the write commands, and allocate a cache space for each of the classified categories from the dynamic random-access memory. For example, the stream classifier 1621 may use the stream ID, the namespace ID, the size of data, the distribution of logical addresses, or a combination thereof described in the aforementioned embodiments to classify the write commands from the host 120.

If the write command is a stream write command, the write command may include a stream ID. Accordingly, the stream classifier 1621 may classify the write command according to the stream ID, and inform the trig engine 1623 of allocating a corresponding cache space for each of the stream IDs from the dynamic random-access memory 166. In addition, the search engine 1622 may convert the start logical address and the sector count indicated by the stream write command to the cache write address and an associated range (e.g., consecutive logical addresses) in the corresponding cache space.

In some embodiments, since each cache space has not stored data yet, in addition to writing data into the corresponding cache space according to the cache write address and the associated range from the search engine 1622, the trig engine 1623 may look up the physical addresses corresponding to the write logical address in the stream write command according to the logical-to-physical mapping table stored in the dynamic random-access memory 166. Then, the trig engine 1623 may write the data indicated by the stream write command into the flash memory according to the looked-up physical address. In some other embodiments, the cache controller 1620 does not write data into the flash memory 180, instead, the cache controller 1620 quickly flushes the data into the flash memory 180 until it is necessary to clean the data in the cache space or the data storage device 140 has encountered a power loss.

When the host 120 repeatedly writes data into the data storage device 140, the computation unit 162 may write the data from the host 120 into the corresponding cache space and the flash memory 180 in a similar manner. If the size of the cache space is sufficient, the trig engine 1623 may fully write the data indicated by the stream write command into the cache space, and the subsequent read commands may read data from the cache space. If the size of the cache space is not sufficient to store all data indicated by the stream write command, the trig engine 1623 may determine which portion of data has to be written into the cache space according to a determination mechanism (e.g., the write order of the data, or unpopular/popular data).

After the electronic system 100 has operated for a time period, the computation unit 162 may accumulate the number of read accesses of data or pages to determine which portion of the data is the frequently-used data or popular data, and read the frequently-used data or popular data from the flash memory 180 that is temporarily stored in each cache space for subsequent read operations. Conversely, the data having a smaller number of read accesses stored in the cache space (e.g., unpopular data) will be flushed or replaced, and the empty cache space may temporarily store popular data.

For example, there are various namespaces in the data storage device 140, and some of the namespaces may have higher priorities and are accessed frequently. For example, given that a first namespace has a size of 20 MB, the cache controller 1620 may allocate a first cache space having a size of at least 10 MB from the dynamic random-access memory 166 to store data in the first namespace. For example, the most frequently-accessed 10 MB of data can be constantly retained in the first cache space, and the remaining 10 MB of data can be stored in the flash memory 180. Accordingly, if the host 120 is to read the data in the first namespace through the first cache space, the hit ratio of the first cache space may reach at least 50%. In other words, the life time of the flash memory corresponding to the first name space can be doubled, and the performance of data access can be significantly improved.

In an embodiment, when the host 120 issues a read command, the search engine 1622 may search from the cache lookup table to determine whether the data indicated by the read command is stored in the cache space. For example, the search engine 1622 may search the cache lookup table according to the start logical address and the sector count indicated by the read command. If all of the second data indicated by the read command is stored in the corresponding cache space, the search engine 1622 may sends a cache start address and length to the trig engine 1623. Then, the trig engine 1623 may retrieve the data from the corresponding cache space according to the cache start address and length, and sends the retrieved data to the host 120.

If the partial data indicated by the read command is stored in the corresponding cache space, the search engine 1622 may sends the cache start address and length to the trig engine 1623, and the trig engine 1623 may retrieve the first portion of data from the corresponding cache space according to the cache start address and length. Additionally, the trig engine 1623 may look-up the logical-to-physical mapping table stored in the dynamic random-access memory 166 to obtain the physical addresses of the second portion of data that is not located in the cache space, and read the second portion of data from the flash memory 180 according to the retrieve physical addresses. Then, the trig engine 1623 may send the first portion of data (e.g., from the cache space) and the second portion of data (e.g., from the flash memory 180) to the host 120.

As depicted in FIG. 2A, if the write command from the host 120 has a start logical address of 16, a sector count of 8, and a stream ID SID0, the trig engine 1623 may write data to the cache space 1630 according to the cache start address and length from the search engine 1622, and the data written into the cache space 1630 has a range of consecutive logical addresses, such as range 1631.

As depicted in FIG. 2B, if the write command from the host 120 has a start logical address of 16, a sector count of 8, and a stream ID SID0, the stream classifier 1621 may recognize the stream ID SID0, and the search engine 1622 may obtain or calculate the cache start address and length in the cache space 1630 corresponding to the stream ID SID0, and transmit the cache start address and length to the trig engine. The trig engine 1623 may obtain the data from the cache space 1630 according to the cache start address and length from the search engine 1622, and transmit the obtained data to the host 120 to complete the read operation.

For example, when both the host 120 and the data storage device 140 support the NVMe 1.3 standard or above, the host 120 may activate the function of “directives and streams” to issue I/O commands to the data storage device 140. Specifically, in the architecture of a prior solid-state disk, when the SSD performs the multiple write operations, there is no unpopular data or popular data for the write operations. That is, the SSD controller may directly write the data into the flash memory in a range of consecutive logical addresses no matter whether the source of the write command is. Since the all the loads are mixed, it may cause the data from different sources to be in the staggered distribution in each of the regions of the flash memory 180, which is disadvantageous for the garbage collection.

In an embodiment, when the host 120 activates the function of “directives and streams” and issues an I/O command to the data storage device 140, the I/O command may have a stream ID, wherein different stream IDs represent different types of data such as sequential data or random data. For example, the sequential data can be classified into log data, database, or multimedia data. The random data can be classified into metadata, or system files, but the invention is not limited thereto. In some embodiments, the host 120 may distribute the stream IDs according to the updating frequency of different types of data.

FIG. 2C is a diagram of writing mixed data of various stream commands into the flash memory in accordance with an embodiment of the invention.

As depicted in FIG. 2C, if any of the host 120 or the data storage device 140 does not support or activate the function of “directives and streams” and the cache spaces are not used, after stream 1, stream 2, and stream 3 (e.g., indicating sequential writing, sequential writing, and random writing, respectively) from the host 120 are transmitted to the computation unit 162, the computation unit 162 may mix the data of different streams and write the mixed data into different blocks 181 of the flash memory 180, such as blocks 181A, 181B, 181D, and 181E. In the embodiment, data is not written into blocks 181C and 181F. However, it can be understood that the data stored in blocks 181A, 181B, 181D, and 181E are mixed data which is disadvantageous for garbage collection.

FIG. 2D is a diagram of writing data of various stream commands into the flash memory according to the stream IDs in various stream commands in accordance with to an embodiment of the invention.

As depicted in FIG. 2D, if both the host 120 or the data storage device 140 support and activate the function of “directives and streams” and the cache spaces are not used, after stream 1, stream 2, and stream 3 (e.g., indicating sequential writing, sequential writing, and random writing, respectively) from the host 120 are transmitted to the computation unit 162, the computation unit 162 may write the data of different streams into different blocks 181 of the flash memory 180 according to the stream IDs of different streams. For example, pages 1821 of block 181A store data of stream 1, and pages 1822 of block 181B store data of stream 2, and pages 1823 of block 181C store data of stream 3. In the embodiment, data is not written into blocks 181D-181F.

FIG. 2E is a diagram of writing data of various stream commands into the flash memory according to the stream IDs in various stream commands in accordance with to an embodiment of the invention.

As depicted in FIG. 2E, if both the host 120 or the data storage device 140 support and activate the function of “directives and streams” and the cache spaces are used, after stream 1, stream 2, and stream 3 (e.g., indicating sequential writing, sequential writing, and random writing, respectively) from the host 120 are transmitted to the computation unit 162, the computation unit 162 may write the data of different streams into different blocks 181 of the flash memory 180 according to the stream IDs of different streams. For example, pages 1821 of block 181A store data of stream 1, and pages 1822 of block 181B store data of stream 2, and pages 1823 of block 181C store data of stream 3. In the embodiment, data is not written into blocks 181D-181F.

In addition, the cache controller 1620 further writes data of stream 1, stream 2, and stream 3 into cache spaces 211, 212, and 213 corresponding to stream IDs of stream 1, stream 2, and stream, respectively. As depicted in FIG. 2E, the cache space 211 stores the data of pages 1821 in block 181A, and the cache space 212 stores the data of pages 1822 in block 181B, and the cache space 213 stores the data of pages 1823 in block 181C. When the cache controller 1620 has received the stream read command (e.g., having a stream ID SID2) from the host 120, the cache controller 1620 may determine that the data corresponding to the stream ID SID2 has been written into cache space 212. Thus, the cache controller 1620 may retrieve the data directly from the cache space 212 and transmit the retrieved data to the host 120 to complete the read operation.

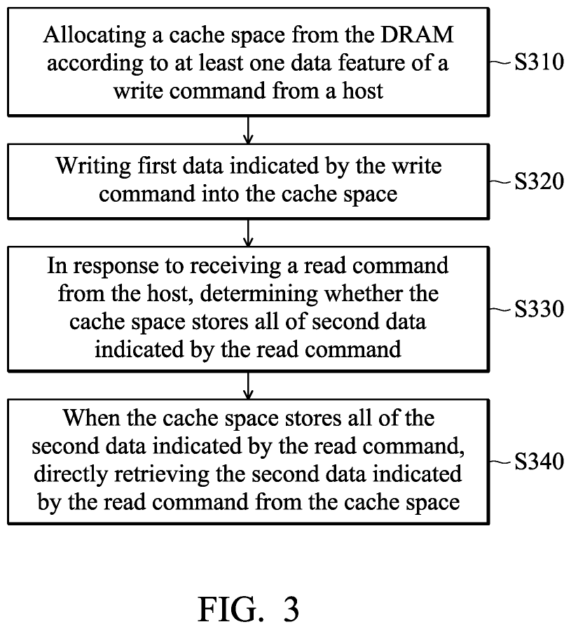

FIG. 3 is a flow chart of a cache-diversion method for use in a data storage device in accordance with an embodiment of the invention.

In step S310, a cache space is allocated from the dynamic random-access memory 166 according to at least one data feature of a write command from the host 120. For example, the data feature may be a stream ID, a namespace ID, the size of the data, the distribution of logical addresses of the write command, or a combination thereof

In step S320, first data indicated by the write command is written into the cache space. It should be noted that, if the size of the cache space is sufficient to store all of the first data indicated by the write command, the trig engine 1623 may write all of the first data indicated by the write command into the cache space without writing the first data indicated by the write command into the flash memory 180, and the subsequent read commands may read data from the cache space. If the size of the cache space is not sufficient to store all of the first data indicated by the write command, the trig engine 1623 may determine which portion of first data has to be written into the cache space according to a determination mechanism (e.g., the write order of the data, or unpopular/popular data).

In step 5330, a read command from the host 120 is responded to determine whether the cache space contains all of the second data indicated by the read command.

In step 5340, when the cache space contains all of the second data indicated by the read command, the second data indicated by the read command is retrieved directly from the cache space, and the retrieved second data is transmitted to the host 120 to complete the read operation.

It should be noted that if the corresponding cache space does not store all of the second data indicated by the read command, the cache controller 1620 may further determine whether the corresponding cache space partially stores the second data indicated by the read command. If the corresponding cache space contains partial second data indicated by the read command, the cache controller 1620 retrieves the partial second data indicated by the read command from the cache space. If the cache space does not store the second data indicated by the read command, the cache controller 1620 retrieves the second data indicated by the read command from the flash memory 180.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory, comprising a plurality of physical blocks for storing data;
a dynamic random-access memory (DRAM); and
a controller, configured to allocate a cache space from the DRAM according to at least one data feature of a write command from a host,
wherein the controller writes first data indicated by the write command into the cache space,
wherein, in response to receiving a read command from the host, the controller determines whether the cache space contains all of the second data indicated by the read command;
when the cache space contains all of the second data indicated by the read command, the controller retrieves the second data indicated by the read command directly from the cache space.

2. The data storage device as claimed in claim 1, wherein the at least one data feature comprises stream ID, namespace ID, size of data, distribution of logical addresses of the write command, or a combination thereof.

3. The data storage device as claimed in claim 1, wherein the cache space has a size, and if the size of the cache space is sufficient to store all of the first data indicated by the write command, the controller writes all of the first data indicated by the write command into the cache space, and does not write the first data indicated by the write command into the flash memory,
if the size of the cache space is not sufficient to store all of the first data indicated write command into the cache space, and writes a remaining portion of the first data indicated by the write command into the flash memory.

4. The data storage device as claimed in claim 3, wherein the first data written into the cache space is frequently-accessed data or popular data.

5. The data storage device as claimed in claim 1, wherein when the cache space does not store all of the second data indicated by the read command, the controller determines whether the cache space contains a portion of the second data indicated by the read command,
if the cache space contains the portion of the second data indicated by the read command, the controller retrieves the portion of the second data indicated by the read command from the cache space, and retrieves a remaining portion of the second data indicated by the read command from the flash memory;
if the cache space does not store the portion of the second data indicated by the read command, the controller retrieves all of the second data indicated by the read command from the flash memory.

6. A cache-diversion method for use in a data storage device, wherein the data storage device comprises a flash memory and a dynamic random-access memory (DRAM), the method comprising:
allocating a cache space from the DRAM according to at least one data feature of a write command from a host;
writing first data indicated by the write command into the cache space;
in response to receiving a read command from the host, determining whether the cache space contains all of the second data indicated by the read command; and
when the cache space contains all of the second data indicated by the read command, retrieving the second data indicated by the read command directly from the cache space.

7. The cache-diversion method as claimed in claim 6, wherein the at least one data feature comprises stream ID, namespace ID, size of data, distribution of logical addresses of the write command, or a combination thereof.

8. The cache-diversion method as claimed in claim 6, further comprising:
if a size of the cache space is sufficient to store all of the first data indicated by the write command, writing all of the first data indicated by the write command into the cache space without writing the first data indicated by the write command into the flash memory,
if the size of the cache space is not sufficient to store all of the first data indicated by the write command, writing a portion of the first data indicated by the write command into the cache space, and writing a remaining portion of the first data indicated by the write command into the flash memory.

9. The cache-diversion method as claimed in claim 8, wherein the first data written into the cache space is frequently-accessed data or popular data.

10. The cache-diversion method as claimed in claim 6, further comprising:
when the cache space does not store all of the second data indicated by the read command, determining whether the cache space contains a portion of the second data indicated by the read command;
if the cache space contains the portion of the second data indicated by the read command, retrieving the portion of the second data indicated by the read command from the cache space, and retrieving the remaining portion of the second data indicated by the read command from the flash memory; and
if the cache space does not store the portion of the second data indicated by the read command, retrieving all of the second data indicated by the read command from the flash memory.
